(19) United States
(12) Patent Application Publication
(10) Pub. No.: US 2026/0049004 A1
(43) Pub. Date: Feb. 19, 2026

(54) Shower Filter

(71) Applicant: Chunmei HUANG, Zhejiang (CN)

(72) Inventor: Chunmei HUANG, Zhejiang (CN)

(21) Appl. No.: 19/366,902

(22) Filed: Oct. 23, 2025

(51) Int. Cl. C02F 1/00; E03C 1/04

(52) U.S. Cl. CPC C02F 1/003; E03C 1/0408; C02F 2201/006; C02F 2307/06; E03C 2201/40

(57) ABSTRACT

The present disclosure relates to a shower filter, comprising a conical housing and a communicating vessel inside the housing. One end of the communicating vessel is connected to the inlet pipe, while the other end is connected to a filter housing containing a removable filter cartridge through a detachable interface, enabling modular maintenance. The housing is equipped with an access port on the side for easy inspection. The bottom of the communicating vessel features an outlet pipe to direct filtered water to an adapter. The adapter controls water diversion through a knob, allowing the option to channel water to either the showerhead or ceiling shower, with all outlets filtered through the same filter cartridge.

### TECHNICAL FIELD

The present disclosure relates to the technical field of shower equipment, particularly to a shower filter.

### BACKGROUND

Most shower filters on the market adopt a fixed “one-inlet-one-outlet” water path design. The inlet end is directly connected to the bathroom wall water pipe, and water can only flow unidirectionally through the internal filter cartridge before being discharged from the sole outlet, which is typically fixed to either a handheld showerhead or a ceiling shower, making it impossible to simultaneously accommodate both components, let alone switch flexibly. Such filters also have limited functionality, offering only water purification without additional practical features. More critically, constrained by the “one-inlet-one-outlet” structure, users must manually unscrew the connection between the filter and the existing outlet component and then reattach another one when switching from a ceiling shower to a handheld showerhead during daily use. This process is not only cumbersome but also prone to causing loose connections and leaks due to repeated disassembly, failing to meet the need for flexible water outlet switching in everyday bathroom scenarios.

Furthermore, existing shower filters exhibit significant shortcomings in structure and maintainability. First, the internal communicating vessel and filter cartridge are often fixed or integrally installed, meaning that when a single component fails or the filter cartridge reaches its lifespan, the entire device must be disassembled or the core assembly replaced, resulting in high maintenance costs and complex operations. Second, the housing structure is simplistic, lacking consideration for maintenance convenience. Routine cleaning or filter cartridge replacement requires removing the entire product from the wall, increasing user effort and time costs. Third, the water path design is rigid, allowing only a single filtered water outlet. It cannot flexibly provide dual water outlet options for both ceiling showers and handheld showerheads while retaining filtration functionality, falling short of modern bathroom systems' multifunctional demands.

### SUMMARY

The present disclosure provides a shower filter to address the issues raised in the background art.

To achieve the above object, the present disclosure adopts the following technical solutions:

A shower filter comprises a shell provided with a water inlet, a first water outlet and a second water outlet; a filtering module, with an inlet end connected to the water inlet; and a water path switching module connected to an outlet end of the filtering module. The water path switching module is configured to receive filtered water flow and, in response to a user operation, selectively direct the filtered water flow to the first water outlet or the second water outlet.

The present disclosure further provides another technical solution: a shower filter, comprising: a shell provided with a water inlet, a first water outlet and a second water outlet; a water flow distribution mechanism arranged inside the shell for receiving water flow from the water inlet; a filtering module arranged inside the shell and connected to the water flow distribution mechanism for filtering the water flow; a water path switching module arranged inside the shell and connected to an outlet end of the filtering module. The water path switching module is configured to receive filtered water flow and, in response to a user operation, selectively direct the filtered water flow to the first water outlet or the second water outlet.

The beneficial effects of the present disclosure compared to the prior art are as below:

The present disclosure achieves systematic operation of filtration and diversion through a one-inlet-two-outlet structure. First, the water flow enters the communicating vessel and is forcibly directed to the filter cartridge, where it is purified, ensuring that the water quality from any outlet is filtered. Subsequently, the purified water flow enters the built-in adapter. By simply rotating the knob, the user can drive the internal valve core to switch the water flow to the pipeline of the ceiling shower or the showerhead, eliminating the need for any pipeline disassembly or assembly and completely removing the hassle of manual pipeline handling. This design not only provides dual purified water enjoyment but also offers advantages such as ease of operation, reliable sealing, and modular maintenance, fundamentally addressing the shortcomings of traditional shower filters, such as single functionality and inconvenient switching.

### BRIEF DESCRIPTION OF DRAWINGS

The drawings, which form part of this application, are intended to provide further understanding of the present disclosure. The illustrative embodiments and descriptions thereof are used to explain the present disclosure and do not constitute an undue limitation of the present disclosure. In the drawings:

FIG. 1 is a perspective schematic view of an embodiment provided by the present disclosure.

FIG. 2 is an exploded schematic view of the housing in the embodiment shown in FIG. 1.

FIG. 3 is a structural schematic view of the interior of the housing in the embodiment shown in FIG. 1.

FIG. 4 is a cross-sectional view of the communicating vessel and filter housing in the embodiment shown in FIG. 3.

FIG. 5 is a structural schematic view of the adjusting component in the embodiment shown in FIG. 1.

FIG. 6 is an exploded schematic view of the adjusting component in the embodiment shown in FIG. 5.

Reference signs: Housing (100); Opening (110); Cover Plate (120); Communicating Vessel (200); First Docking Port (210); Second Docking Port (220); Outlet Pipe (230); Filter Element (300); Filter Cartridge (310); Filter Housing (320); Supporting Plate (321); Adapter (400); Connecting Cylinder (410); First Pipeline (420); Second Pipeline (430); Third Pipeline (440); Adjusting Component (450); Knob (451); Rotating Shaft (452); Plugging Block (453); Spring (454); First Water Pipe (500); Showerhead (510); Second Water Pipe (600); Ceiling Shower (610); Inlet Pipe (700); Water Flow Direction (A).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

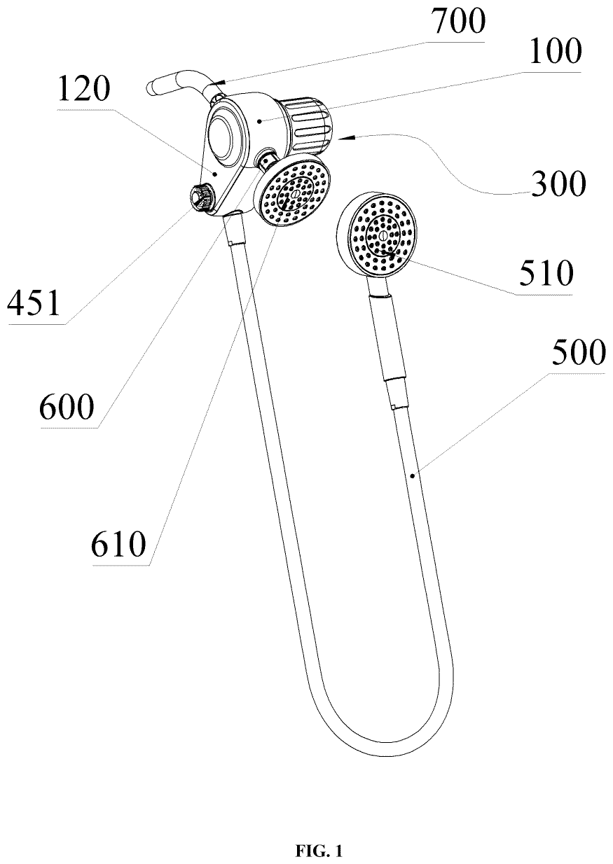

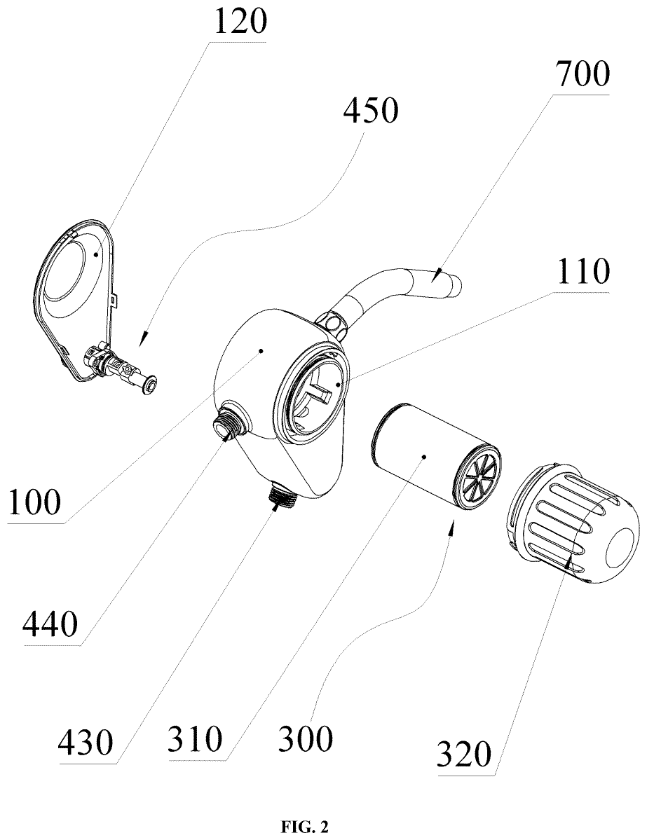

Please refer to FIGS. 1 and 2. A shower filter includes a housing 100 and an inlet pipe 700. A communicating vessel 200 is arranged inside the housing 100, and a filter element 300 is provided at one end of the communicating vessel 200.

In the present disclosure, the housing 100 is generally conical in shape. In other optional embodiments, the housing 100 may be circular or of another specific shape.

Here, the communicating vessel 200 and the housing 100 are detachably installed using bolts or snaps. Bolt connections provide greater structural rigidity and sealing pressure, making them suitable for scenarios requiring reliable fixation. Snap connections, on the other hand, prioritize ease of installation and allow for quick tool-free disassembly. Both methods ensure that the communicating vessel 200 can be removed as a whole from the housing, offering significant convenience for subsequent cleaning, maintenance, or replacement.

In other embodiments (not shown), the front end of the inlet pipe 700 is integrated with a primary pre-filter screen for intercepting large particulate impurities. This filter screen is designed as a rotatable scraping structure, where manually rotating the external knob drives the built-in scraper to remove accumulated dirt on the screen surface. The scraped-off impurities are discharged with a small amount of flushing water through a specially designed drain port at the bottom. This design effectively reduces the load on the filter element, extends its service life, and simplifies daily maintenance.

In other embodiments, referring to FIGS. 1 and 2, the side of the housing 100 is equipped with a dedicated access port and a removable cover plate 120. This design allows maintenance personnel to directly access internal components by opening the cover plate without disassembling the entire housing, enabling quick inspection, replacement, or routine maintenance of key parts such as the communicating vessel and filter cartridge. This significantly improves the convenience and efficiency of equipment maintenance.

It should be noted that the cover plate 120 can be installed on the housing 100 through bolts or snap-fit mechanisms.

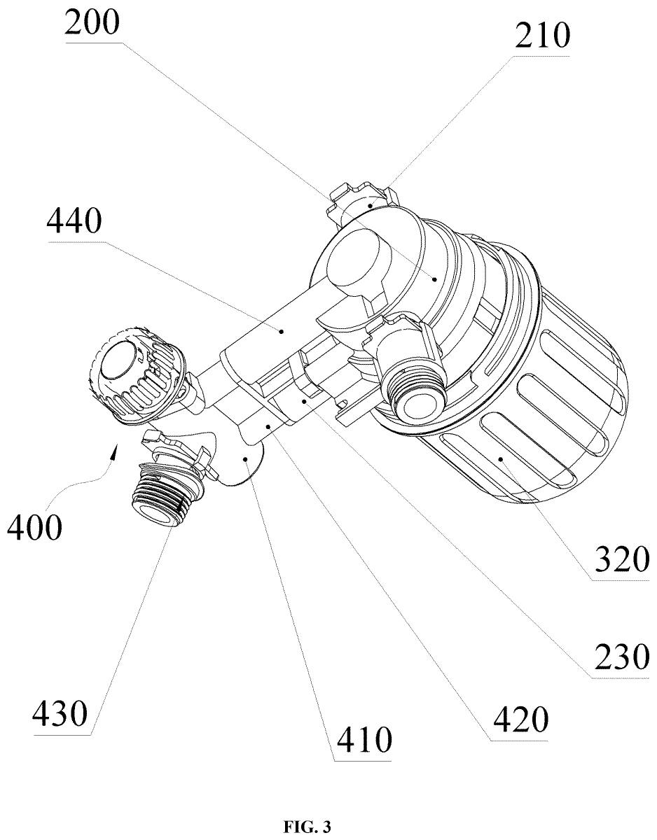

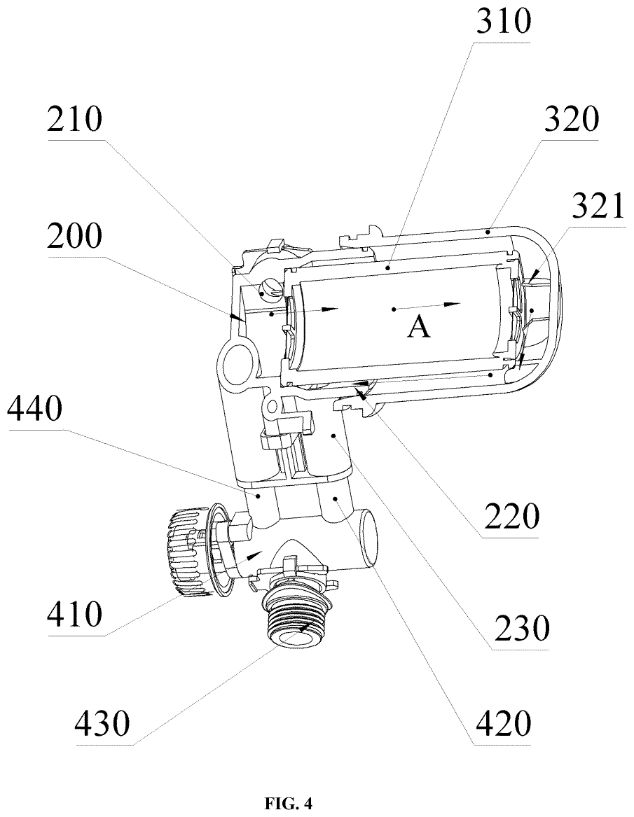

In this embodiment, referring to FIGS. 1, 2, 3, and 4, one end of the communicating vessel 200 is provided with a first docking port 210, and one end of the first docking port 210 extends to the exterior of the housing 100 and is connected to the inlet pipe 700. This allows water to enter the interior of the communicating vessel 200 through the first docking port 210.

In other embodiments, referring to FIGS. 1, 2, 3, and 4, one end of the housing 100 is provided with an opening 110, and the communicating vessel 200 is equipped with a second docking port 220 corresponding to this opening. The filter element 300 includes a filter cartridge 310, one end of which is docked with the second docking port 220 through the opening 110. Thus, water entering the communicating vessel 200 will be filtered through the filter cartridge 310.

Regarding the filling configuration of the filter cartridge 310, two options are provided: one involves filling a single type of filter medium to achieve core filtration, while the other involves filling a plurality of different filter media to form a multi-stage filtration system through specific combinations. This aims to remove various types of impurities from water step by step, enhancing overall filtration efficiency and effectiveness.

In other embodiments, the connection between the filter cartridge 310 and the second docking port 220 is detachable. Specifically, threaded connections can be used for secure sealing, or magnetic or snap-fit methods can be employed for quick assembly and replacement.

In other embodiments, referring to FIGS. 1, 2, 3, and 4, the filter element 300 also includes a filter housing 320, which is installed in the opening 110, while the filter cartridge 310 is housed inside this filter housing 320. This design provides structural support and protection for the filter cartridge while also enabling its modular independence, facilitating overall maintenance and replacement.

It should be noted that after the filter housing 320 is installed, an annular clearance is formed between it and the internal filter cartridge 310. Simultaneously, when the filter cartridge 310 is installed, part of its outer side is covered by the second docking port 220. An annular clearance is also reserved between the two. This design not only provides guidance and tolerance space for the installation and removal of the filter cartridge but also serves as a water flow channel, further avoiding assembly stress caused by machining or thermal expansion errors.

In this embodiment, to ensure the reliability of the system's sealing, this embodiment adopts a dual-sealing design: first, a sealing ring is placed on the mating surface between the filter housing 320 and the housing opening 110 to prevent water leakage from the housing; second, a sealing ring is set on the joint surface between the second docking port 220 and the filter cartridge 310, ensuring filtration effectiveness.

In other embodiments, the connection between the filter housing 320 and the opening 110 is detachable. Specifically, threaded connections can be used to achieve a secure seal, or magnetic or snap-fit methods can be chosen for quick assembly and replacement.

In other embodiments (not shown), the filter cartridge 310 and the second docking port 220 are connected using standardized quick-connect fittings, enabling plug-and-play and push-to-replace functionality. Additionally, a transparent viewing window is installed on the housing 100, paired with an electronic tag or mechanical counter on the filter cartridge 310, allowing users to directly observe the usage status or remaining lifespan of the filter cartridge 310. This facilitates replacement at the optimal time, enhancing user experience and maintenance precision.

In other implementations, referring to FIGS. 1, 2, 3, and 4, the filter housing 320 has a plurality of supporting plates 321 fixed to its inner bottom wall (i.e., the end farthest from the opening 110). This component serves both supporting and positioning functions: during installation, it supports the end of the filter cartridge 310, providing stable axial support; meanwhile, its specific structure ensures a preset gap is maintained between the end of the filter cartridge and the bottom of the filter housing. This gap can serve as a water flow channel.

In other implementations (not shown), a plurality of supporting plates 321 are equipped with embedding grooves that match the shape of the filter cartridge 310's end. During installation, the end of the filter cartridge 310 snaps into the grooves. This structure not only provides additional radial support but also effectively prevents the filter cartridge 310 from shifting or loosening during operation, significantly improving connection stability and reliability.

In other embodiments, referring to FIGS. 1, 2, 3, and 4, the bottom of the communicating vessel 200 is equipped with an outlet pipe 230. The outlet pipe 230 is located between the connection point of the second docking port 220 and the filter cartridge 310, and the annular clearance formed between the filter housing 320 and the filter cartridge 310. This allows the water source, after being filtered by the filter cartridge 310, to be efficiently diverted through the gap and annular clearance to the outlet pipe 230, thereby enabling the discharge of the water source.

In this embodiment, the interior of the housing 100, located below the communicating vessel 200, is equipped with an adapter 400. The adapter 400 includes a connecting cylinder 410, on which a first pipeline 420 is fixedly installed. The first pipeline 420 is connected to the outlet pipe 230, allowing the filtered water source to be guided through the outlet pipe 230 and the first pipeline 420, thereby entering the connecting cylinder 410.

In other embodiments, referring to FIGS. 1, 2, 3, and 4, the connecting cylinder 410 is provided with a second pipeline 430 and a third pipeline 440 to achieve dual-path water discharge. The second pipeline 430 extends to the exterior of the housing 100 and is connected to a first water pipe 500, the other end of which is fixedly installed with a showerhead 510. The third pipeline 440 is connected to a second water pipe 600, the other end of which extends to the surface of the housing 100 and is fixedly installed with a ceiling shower 610.

Here, a portion of the second water pipe 500 is embedded into the communicating vessel 200, providing additional support for the second water pipe 600. This structure effectively disperses the torque caused by the ceiling shower, reduces pipeline vibration, and enhances the overall reliability of the system.

In other embodiments, the connecting cylinder 410 is internally equipped with an adjusting component 450, which is used to divert the water path, controlling the water flow to either the second pipeline 430 or the third pipeline 440.

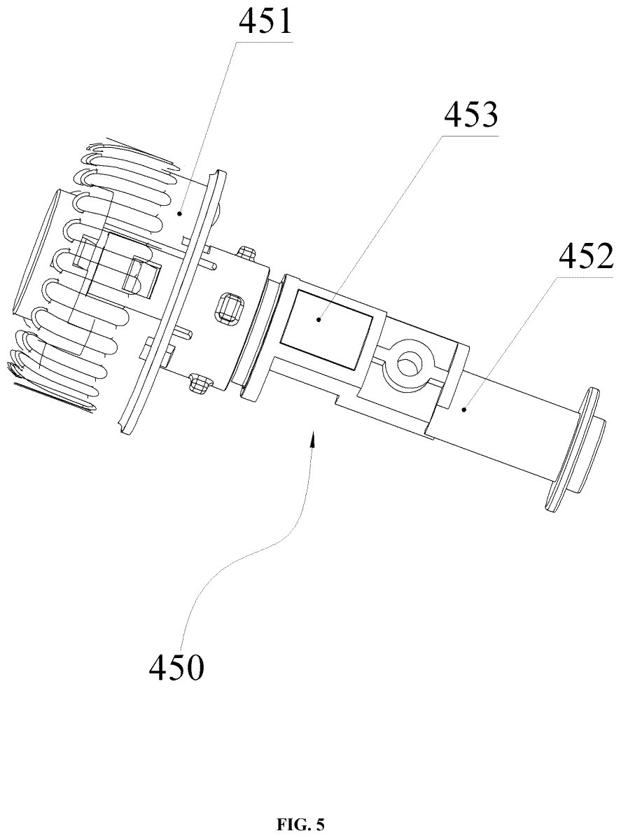

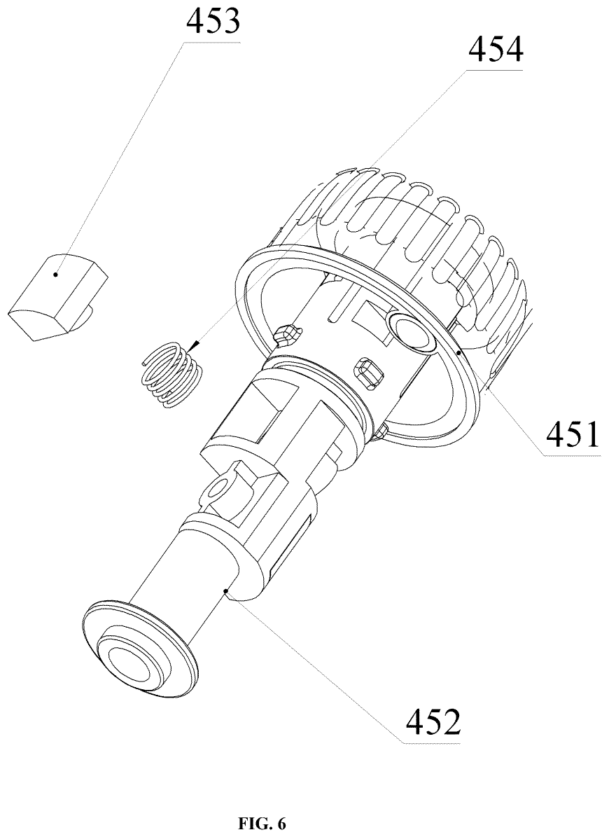

Here, referring to FIGS. 5 and 6, the adjusting component 450 includes a knob 451 rotatably installed on the surface of the cover plate 120 away from the housing 100. The knob 451 is fixedly equipped with a rotating shaft 452 that movably penetrates the cover plate 120. When the cover plate 120 is installed onto the housing 100, the rotating shaft 452 can be inserted into the connecting cylinder 410. The surface of the rotating shaft 452 is provided with two grooves, each embedded with a plugging block 453, and the positions of the two plugging blocks 453 are staggered. When the knob 451 is rotated, the rotating shaft 452 turns accordingly, causing one plugging block 453 to block the inlet port of the second pipeline 430 while the other remains unblocked, allowing water to flow through the third pipeline 440 in a single path. Rotating the knob 451 in the opposite direction achieves the reverse on-off effect, thereby completing the selective switching of the dual water paths.

In other embodiments, referring to FIGS. 5 and 6, a spring 454 is fixed to the inner wall at the bottom of the groove, with its other end connected to a plugging block 453. When the knob 451 is rotated to a specific position, aligning the plugging block 453 with the corresponding pipeline inlet, part of the plugging block 453 is pushed into the pipeline inlet under the force of the spring. This action creates a slight radial displacement, generating noticeable mechanical resistance against the continuously rotating knob, providing the user with a clear tactile feedback. This haptic feedback directly signals to the user that the current pipeline is reliably sealed and the water path switching is complete.

It should be noted that to achieve reliable sealing and clear tactile feedback, the plugging block 453 adopts a composite structure combining a rigid core and a soft outer layer. Internally, it requires hard engineering plastics such as POM (polyoxymethylene) or nylon as the core skeleton to provide solid support and translate the spring force into distinct tactile feedback. The outer layer is coated with elastic materials like NBR (nitrile rubber) or silicone, utilizing their flexibility to deform and tightly conform to the pipeline inlet during sealing, thereby achieving static sealing and cushioning. This design ensures both precise operational feel and long-term sealing reliability.

In other embodiments (not shown), the bottom of the communicating vessel 200 is radially connected to a plurality of second docking ports 220, while the housing 100 has an equal number of openings 110 at corresponding positions, and each opening 110 is equipped with an independent filter element 300. These filter elements 300 can be filled with different functional filter media (e.g., softening resin, activated carbon, KDF, etc.), forming a parallel multi-stage filtration system. Users can activate specific filter cartridges 310 based on water quality needs or control the water flow through different combinations of filter cartridges 310 through a multi-way valve in the adapter 400, enabling customized filtration and extended filter replacement cycles.

In summary, as can be seen from the above description, the present disclosure achieves the following technical effects:

The present disclosure realizes systematic operation of filtration and diversion through a one-inlet-two-outlet structure. First, water entering the communicating vessel 200 is forcibly directed to the filter cartridge 310, where it is purified, ensuring filtered water quality at any outlet. Subsequently, the purified water flows into the built-in adapter 400, where the user only needs to rotate the knob 451 to drive the internal valve core, effortlessly switching the water flow to the pipeline of either the ceiling shower 610 or the showerhead 510. The entire process eliminates the need for any pipeline disassembly, completely removing the hassle of manual pipe handling. This design not only provides dual purified water enjoyment but also offers advantages such as ease of operation, reliable sealing, and modular maintenance, fundamentally addressing the shortcomings of traditional shower filters, such as limited functionality and inconvenient switching.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A shower filter, comprising:
a shell provided with a water inlet, a first water outlet and a second water outlet;
a filtering module, with an inlet end connected to the water inlet; and
a water path switching module connected to an outlet end of the filtering module;
wherein the water path switching module is configured to receive filtered water flow and, in response to a user operation, selectively direct the filtered water flow to the first water outlet or the second water outlet.

2. The shower filter according to claim 1, wherein the filtering module is detachably connected to the shell.

3. The shower filter according to claim 1, wherein the filtering module comprises a filter cartridge and a detachable filter housing for accommodating the filter cartridge.

4. The shower filter according to claim 1, wherein the water path switching module comprises a valve body and a valve core, and switching of a water path is achieved by driving the valve core.

5. The shower filter according to claim 4, wherein the valve core switches the water path through rotational motion.

6. The shower filter according to claim 5, wherein the valve core is provided with a plugging part, and the plugging part, when the valve core is rotated to a specific position, is engaged with a flow passage opening in the valve body to block one water flow path.

7. The shower filter according to claim 6, wherein an elastic element is arranged between the plugging part and the valve core, providing tactile feedback when the plugging part is engaged with the flow passage opening.

8. The shower filter according to claim 1, wherein the shell further comprises a water flow distribution mechanism to guide water from the water inlet to the filtering module.

9. The shower filter according to claim 3, wherein the filter housing is provided with a supporting structure to support the filter cartridge, and a water flow channel is formed between the supporting structure and an inner wall of the filter housing.

10. The shower filter according to claim 1, wherein the first water outlet is connected to a ceiling shower, and the second water outlet is connected to a handheld showerhead.

11. A shower filter, comprising:
a shell provided with a water inlet, a first water outlet and a second water outlet;
a water flow distribution mechanism arranged inside the shell for receiving water flow from the water inlet;
a filtering module arranged inside the shell and connected to the water flow distribution mechanism for filtering the water flow;
a water path switching module arranged inside the shell and connected to an outlet end of the filtering module; and
wherein the water path switching module is configured to receive filtered water flow and, in response to a user operation, selectively direct the filtered water flow to the first water outlet or the second water outlet.

12. The shower filter according to claim 11, wherein the water flow distribution mechanism is a communicating vessel having a first docking port connected to the water inlet and a second docking port connected to the filtering module.

13. The shower filter according to claim 12, wherein the filtering module comprises a filter cartridge and a filter housing, and the filter housing is detachably mounted on the shell through threaded connection or snap-fit.

14. The shower filter according to claim 13, wherein the filter cartridge is detachably connected to the second docking port of the water flow distribution mechanism through threaded connection, magnetic attraction, or snap-fit.

15. The shower filter according to claim 11, wherein the water path switching module comprises a connecting cylinder, and the connecting cylinder is provided with a first pipeline connected to the outlet end of the filtering module, a second pipeline connected to the first water outlet, and a third pipeline connected to the second water outlet.

16. The shower filter according to claim 15, wherein the water path switching module further comprises a knob having a valve core inserted into the connecting cylinder, and the knob drives the valve core inserted inside the connecting cylinder to switch a water path.

17. The shower filter according to claim 16, wherein the valve core is provided with at least one plugging block, and a groove is formed at a corresponding position on the valve core, with the plugging block installed in the groove through a spring, so that when the knob rotates the valve core to a specific position, the plugging block pops out under a spring force and blocks an inlet port of a corresponding pipeline.

18. The shower filter according to claim 17, wherein the plugging block has a composite structure, with a hard plastic core inside and an outer layer coated with an elastic sealing material.

19. The shower filter according to claim 13, wherein an inner wall of a bottom of the filter housing is fixedly provided with a plurality of supporting plates, and the supporting plates are provided with embedding grooves matching a shape of an end of the filter cartridge.

20. The shower filter according to claim 11, wherein a side of the shell is provided with a detachable cover plate for providing a maintenance access to internal components.
